(19) United States
(12) Patent Application Publication
(10) Pub. No.: US 2015/0074012 A1
(43) Pub. Date: Mar. 12, 2015

(54) SERVER EQUIPMENT AND METHOD FOR ARRANGING OF TRANSPORTATION AND REDUCTION OF EMISSIONS

(71) Applicants: Jarmo Talvitie, Tuusula (FI); Johanna Pyhala, Helsinki (FI)

(72) Inventors: Jarmo Talvitie, Tuusula (FI); Johanna Pyhala, Helsinki (FI)

(73) Assignee: WEIGHTLOCKER OY, Tuusula (FI)

(21) Appl. No.: 14/394,944

(22) PCT Filed: Apr. 17, 2012
(86) PCT No.: PCT/FI2012/050374

§ 371 Date: Oct. 16, 2014

(51) Int. Cl. G06Q 10/08

(52) U.S. Cl. CPC G06Q 10/083
USPC 705/337

(57) ABSTRACT

Server equipment, a system and a method are configured to receive cargo data or other data related to the transportation of cargo or to travel. Data is registered for one or more parties of the cargo, for example, on a central server. On the basis of the data, one can separate and/or link the data regarding two or more pieces of air cargo or other cargo at least part of which is transported using another means of transportation, for example transportation by road. Cargo can also refer to a passenger.

### TECHNICAL FIELD

The present invention relates to transportation logistics. In particular, the present invention relates to transportation logistics in connection with air cargo and the reduction of emissions related to it.

### BACKGROUND

The transportation of persons and goods has faced great challenges lately as concerns emissions related to transportation. Earlier, emissions did not play a critical or central role in transportation. The greenhouse effect and carbon dioxide and other emissions have, however, generated whole new challenges to the transportation of persons and goods. Increased fuel costs have also become a central factor in this business.

Usually, the focus has been mainly to improve the efficiency of individual types of transportation vehicle, such as the plane, the train etc. There have also been efforts to limit or decrease transportation, for example, with the help of remote access.

Carrying of baggage often reduces travel comfort. This is especially the case with baggage that is larger, heavier and/or bulkier than hand luggage. On airports, the traveller usually carries all of this him/herself all the way to the check-in desk in addition to which typically traveling part of the route—before and after the actual flight—carrying his/her baggage using another means of transportation, usually a car, a bus, a train or a subway. In these situations, baggage typically reduces travel comfort, and when pressed for time, may even be the cause for arriving too late. In some situations, baggage may present a safety risk—for example, crossing the street more slowly due to baggage, or, when traveling with one or more children, looking after the children is more difficult (for example having to carry a suitcase instead of holding the child's hand).

The advantage of air cargo, in relation to other forms of transportation, is especially its speed. There are situations, where choosing air cargo is justified. The downside of air cargo is that its emissions are larger than other forms of transportation, which may be a problem especially for a company or other organization seeking to cut its emissions.

The emissions caused by the transportation of cargo can be calculated with a reasonable accuracy. The quantity of emissions depends essentially on the means of transportation used. What means of transportation is chosen is most of all based on a speed and a price. The problem is that choosing the means of transportation on the basis of other criteria than emissions, one may end up with transportation that is in respect of emissions less favourable than another means of transportation. This is especially the case when choosing transportation by air. On the other hand, cargo is transported by means that cause emissions to an unfavourable degree, in particular by air, even when the cargo in question would be suited for another means of transportation that causes less emissions.

It is possible to send on baggage separately using a transportation company offering such services. The problem with such an arrangement is that the transportation of the baggage must be agreed upon and paid separately, even when the price of the airline ticket includes the transportation of baggage. The solution is not related to the flight in any way, and the airline would not even be aware of it.

One of the situations decreasing the efficiency of the airplane occurs when the airplane is not loaded to a preferred degree. In order to minimize unused transportation capacity, airlines sell more passenger tickets or cargo space on a single flight than the airplane's capacity would allow (so-called overbooking). This is in particular due to the fact that some of the passengers or other cargo does not show up for one reason or other, or does not make it in time to the flight. Overbooking may result in some of the passengers, their baggage and/or other cargo destined for the airplane not fitting into the airplane. This causes unnecessary costs and customer dissatisfaction.

The present invention is targeted to solve one or more of the problems presented above.

### SUMMARY

An objective of the present invention is to improve the efficiency of the logistics related to the transportation of persons and/or goods, especially as regards transportation by air.

According to an aspect, the present invention relates to a server equipment that is configured to receive at least two types of cargo data, a part of which concerns cargo travelling by air and a part of which covers cargo travelling by other means, wherein the at least two pieces of cargo data are associated with each other. The server equipment is configured to link the at least two pieces of received cargo data to each other.

In an exemplary embodiment of the invention, the server equipment can also be configured to separate and/or link to each other the data related to two or more pieces of air or other cargo, of which at least a part is transported by another means, for example, by road.

In one exemplary embodiment of the invention, the server equipment can be configured to detect from the cargo data emission data associated with the air cargo. The server equipment can be configured to register the emission data of air cargo to one or more parties involved with the air cargo, wherein the emission data is registered by the server equipment.

In one exemplary embodiment of the invention, the server equipment can be configured to transfer cargo data to one or more providers of transportation services and/or airlines, wherein the cargo data can made accessible to one or more providers of transportation services and/or airlines. Then, one or more providers of transportation services and/or airlines can be configured to arrange the transportation of cargo on the basis of the cargo data.

According to another aspect of the present invention a method comprising receiving at least two pieces of cargo data, a part of which concerns cargo travelling by air and a part of which covers cargo travelling by other means, wherein the at least two pieces of cargo data are associated with each other. The method comprises linking the at least two pieces of cargo data to each other.

According to another aspect of the present invention, an airline ticket is configured to the server equipment in accordance with the present invention or to operate in accordance with the present invention. According to other aspects, the present invention covers air cargo that is configured to server equipment in accordance with the present invention or to operate in accordance with the present invention. According to another aspect, the present invention covers a provider of transportation services that is configured to be in contact with the server equipment in accordance with the present invention, wherein cargo data can be made accessible to the provider of transportation services and in which case the provider of transportation services can be configured to arrange the transportation of cargo on the basis of the cargo data. According to another aspect, the present invention covers an airline that is configured to be in contact with the server equipment in accordance with the present invention, wherein the airline can be configured to arrange the transportation of cargo on the basis of the cargo data.

At least one of the afore-mentioned implementation examples offers one or more solutions to the problems and disadvantages of known prior art. Other technological benefits of the present invention become evident to a person skilled in the art from the following description and the claims. The numerous examples of implementing the present invention achieve only a part of the presented advantages. None of the advantages is critical to the examples of implementation. Any required embodiment can technically be combined with any other required embodiment. The examples represent only a few advantageous embodiments and they do not limit the idea of the invention that can be implemented even in other manners within the framework of the claims presented further below.

### BRIEF DESCRIPTION OF THE DRAWINGS

The attached figures illustrate examples of embodiments of the present invention, and together with the above general description and the detailed current embodiments help explain, by way of examples, the principles of the invention.

FIG. 1 is a schematic image of a logistics server management system showing the airline passenger and the cargo of the airline passenger being arranged in accordance with one exemplary embodiment the present invention;

FIG. 2 is a schematic image of a logistics server management system showing the air cargo being arranged in accordance with another exemplary embodiment the present invention;

FIG. 3 is a schematic image of a logistics server management system showing the structure of the system in accordance with one exemplary embodiment the present invention;

FIG. 4 is a schematic image of the flight process where the flight is arranged in accordance with one exemplary embodiment;

FIG. 5 is a schematic image of the dispatch process of cargo where the cargo is arranged in accordance with one exemplary embodiment of the present invention;

FIG. 6 is a schematic image of the reception process of cargo where the cargo is arranged in accordance with one exemplary embodiment of the present invention;

FIG. 7 shows the central server equipment that can be configured in accordance with certain exemplary embodiments of the present invention;

FIG. 8 shows a schematic flow chart of the logistics process of air cargo in accordance with one exemplary embodiment of the present invention.

### DETAILED DESCRIPTION

Some of the examples of implementation of the present invention disclose a server equipment, a system and a method that are configured to receive cargo data or other data related to the transportation of cargo or travelling. This kind of data is registered for one or more parties of air cargo, for example, on a central server. On the basis of the data, one is able to separate and/or link the data related to two or more pieces of air cargo or other cargo of which at least a part is transported using another means of transportation, for example, transportation by road. Cargo may also stand for a passenger.

The server equipment and the method according to some embodiments of the invention may reduce emissions related to the transportation of cargo by arranging the logistics of the cargo and transportation. Preferably, cargo may, with the help of logistics, be arranged between transportation by air and land. Transportation by land may refer to a car, a truck, a train, a subway and/or even a ship or a vessel. In one exemplary embodiment, the airline traveller's baggage, that in prior art is transported as air cargo, can be arranged to be transported by land, either by train or on wheels, or by sea (or a combination of these). Now, cargo can be transported to its destination using means of transportation causing fewer emissions. Thereby, air cargo capacity is saved. It can be registered and used immediately to transport other air cargo, or a corresponding quantity of air cargo transported earlier or later can be targeted at air cargo capacity made available this way. This can improve the degree of filling or efficiency of one airplane or, when examining one or more airlines, the degree of filling or efficiency of such a larger entity, and it can also affect the price of the airline ticket or the freight etc. Preferably, by linking cargo data, air cargo can also in some cases be transported on the basis of the emissions of land transportation due to the transfer of registered emission data.

An objective of an exemplary embodiment of the invention is to improve the efficiency of the passenger transportation and/or air cargo and to increase of travel comfort, especially when travelling by air. The objective of the invention is also to enable the use of the desired form of transportation, especially by air, or a combination of forms of transportation in the transporting of goods so that the emissions caused by another form of transportation, for example, transportation by train, car or sea, or a combination thereof, can be regarded as the emissions of the said transportation.

An exemplary embodiment of the invention enables a form of transportation with less emissions for such cargo, that allows this form of transportation for example in respect of its schedule, enabling thereby the transportation capacity, that has become available, to be used to transport such cargo (substitutive cargo), for which such a form of transportation with more emissions is necessary, e.g. due to its speed. Therefore, this embodiment example can be used to aim at decreasing emissions of the whole logistics.

In an exemplary embodiment of the invention, data can be recorded that the passenger accepts a delay of the flight or of the baggage so that parties involved in the transportation are aware of this already when transporting. This circumstance and, if desired, also the length of the acceptable delay can also be marked on the baggage. This kind of data can also be recorded for other cargo and marked on such cargo. Thus the personnel handling baggage and other cargo can without any separate measures take this circumstance into consideration, for example, in a situation where only part of the passengers, baggage or other cargo meant for a flight de facto fits into the plane. Thus customer satisfaction is improved, when the delay caused by the selective elimination is not directed to someone to whom it would cause inconvenience, but to a passenger or cargo partner accepting it. The system enables an airline to engage in more extensive overbooking than usual, which increases the degree of filling, to the advantage of profitability and the climate. The acceptance regarding the delay can be made by the passenger, the sender or other party involved in the cargo.

In an exemplary embodiment of the invention, a passenger can also, either bindingly or non-bindingly, declare to be ready, if necessary, to change his/her flight, which offers the airline the possibility to re-sell a flight with high demand for better profit close to the time of the flight and thereby improve the filling degree/efficiency of their flights and/or customer satisfaction.

An exemplary embodiment of the present invention covers emission data, for example, carbon dioxide emission data. Emission data relates to emissions that are generated by the transportation of cargo to its destination using a chosen form or forms of transportation. Emission data can cover in addition to carbon dioxide emissions or instead of them to other harmful emissions. Emission data can also cover the weight, measurements or form of the cargo or the length of the journey of the cargo and possible other factors effecting the emissions. From the cargo data, emission data associated with the transportation of cargo can be identified. The emission data for cargo is registered for one or more parties of the cargo. The emission data is now registered, for example, on a central server. The server is arranged to forward the emission data to the providers of the transportation service or the orderers. Thereby, the emission data of the cargo can be made available to the providers or orderers of the transportation service. Thereby, providers of transportation service can be configured to organize the transportation of the cargo on the basis of the said emission data.

An exemplary embodiment of the invention covers an airline ticket that is configured with the server equipment and the method. Now, the airline ticket can forward and engage in the exchange of data with the server. An embodiment of the present invention covers air cargo that is configured with the server equipment, system and/or method. Thereby, air cargo can be transported so that the data regarding the air cargo is received and sent to the server in order for the air cargo data to be registered.

An embodiment of the present invention covers the provider of the transportation service configured to be in contact with the central server equipment. Thereby, cargo data can be made available to the providers of the transportation service. Then the providers of the transportation service can be configured to organize the transportation of the cargo on the basis of the said data. An embodiment of the invention covers the airline that is configured to be in contact with server equipment in accordance with the present invention. Thereby, the cargo data of the air cargo can be made available to the airline. The airline can be configured to organize the transportation of the air cargo on the basis of the said cargo data.

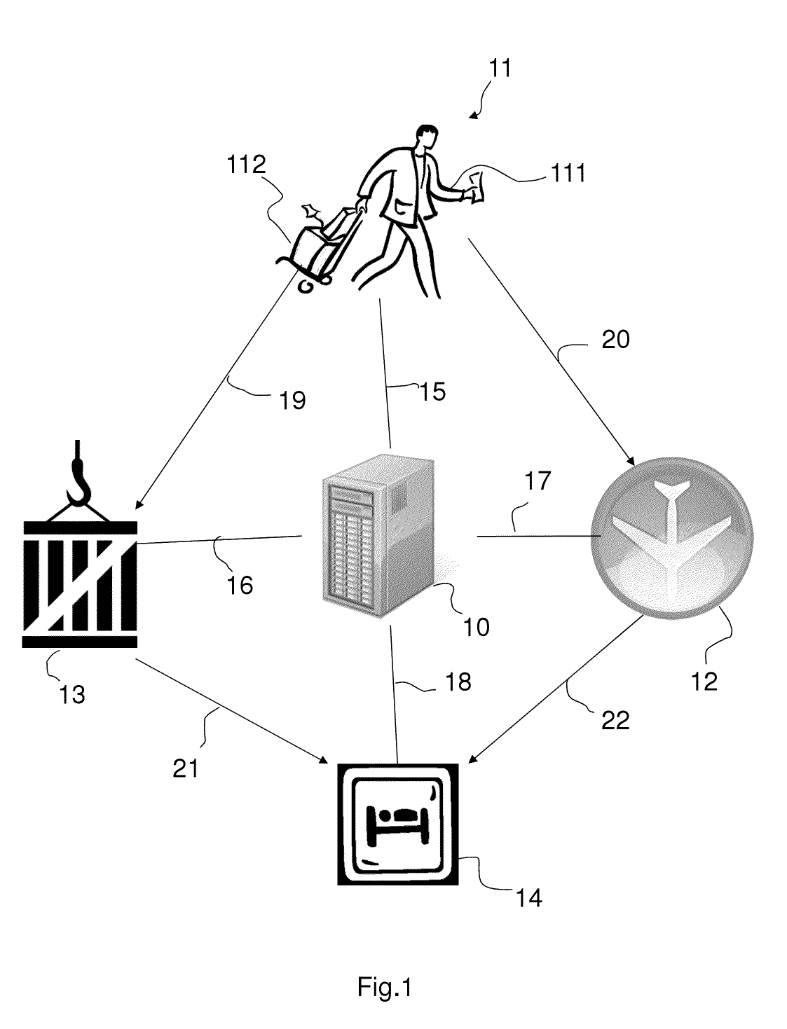

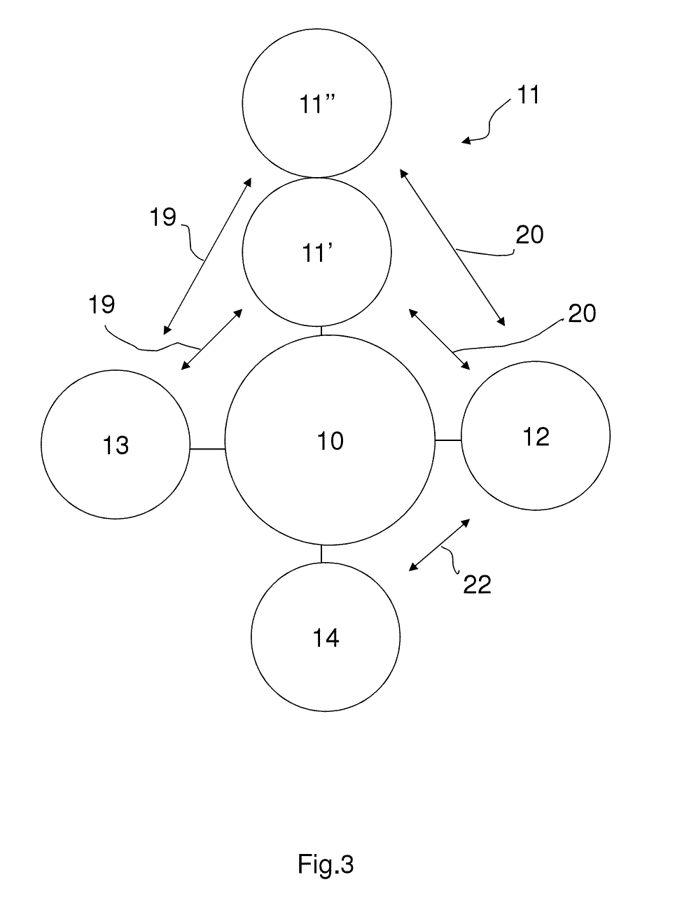

FIGS. 1, 2 and 3 show some embodiments of the present invention, illustrating the structure, parties and action of the system. The system of FIG. 3 comprises the server 10.

Advantageously, the server 10 can be a central server or a cloud server, comprising, for example, of one or more logic and/or physical units. The server 10 can also be decentralized, for example divided by the parties of the system or others, in which case there is no physical central server as such. Now, the data systems of the parties establish an entirety corresponding to the server 10.

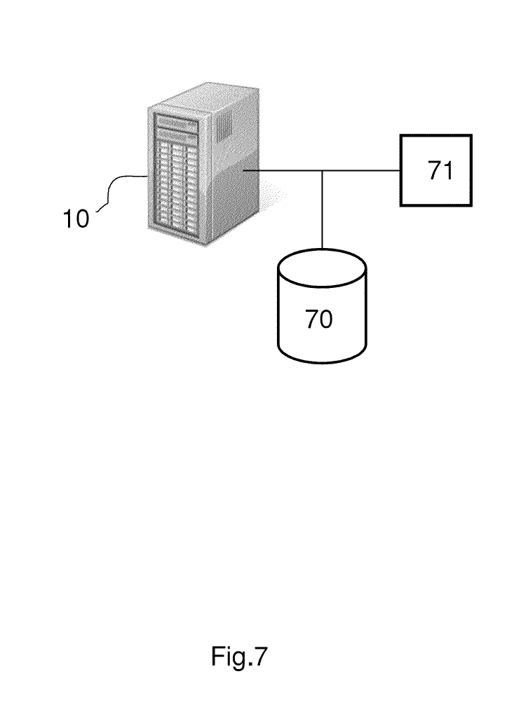

The server 10 is in contact with 15 with the passenger 11. The passenger 11 can be an ordinary airline passenger 11′ or an organization 11″. Data of the passenger 11 can be located in the database of the server 10 as cargo data (FIG. 7 reference 70). From the database 70 and the server 10, there is being configured a two-way connection 15 to the data of the person. In addition, data of the passenger 11 can exist in database of the travel agency and the airline 12 (frequent flyer miles etc.) and the database of the organization (e.g. employer) 11″.

In the embodiment of FIG. 1, cargo 11 comprises goods cargo 112 and the passengers 111. In one embodiment, the passenger 11 does not have any goods cargo 112, for example, baggage to be checked in, or the baggage is registered to be transported using other means of transportation, for example, by road or sea. Now, the system can treat the passenger 11 as a special passenger, and his/her (air) cargo capacity can be registered and, if needed, used.

As one example, a family of four that wishes to check in only one suitcase of a total of four suitcases. Three of them are special passengers and one is not. However, should the special passenger have baggage to be checked in, it may happen that it exceeds the baggage allowance, and such a cargo may present extra load. Such cargo can be compared with cargo that in the known logistics solution differs from or exceeds the allowed baggage either in respect of quantity or measurements, causing the need for further fuel or other action related to the transportation.

The system in FIG. 3 covers also a passenger 11′ belonging to organization 11″. His/her data are in the database 70 of the server. A two-way connection 15 has been arranged from the database 70 to business travel and cargo data of the organization 11″ in the database of the organization and/or the company's travel agency and/or the airline 12 and/or the transportation company 13 (alternatively referencing a forwarding company or airline operation that is used to transport the cargo in an essentially different manner than by air).

In an embodiment, the organization 11″ is a company with one or more airline passengers that as an organization, in order to cut down on their emissions, encourages their staff to travel preferably using airline 12, especially in accordance with the present invention and/or to prefer such an airline when sending and receiving air cargo 112 and especially using cargo space made or becoming available in accordance with the invention at hand.

In an embodiment, the organization 11″ covers also, for example, associations, governmental or municipal institutions and other entities as well as organizations and other bodies that may track the amount and type of emissions caused by themselves. In an embodiment, an organization also sends and/or receives cargo.

Flights of airline 12 that have been registered on the server 10 can be operated in accordance with an embodiment of the invention aiming at the decrease of emissions. For example, the passenger 11 may choose to what extent to check in baggage 112 or to do so at all, and air cargo data and/or data of emissions saved thereby can be registered on the server 10. The passenger 11 can also choose the transportation of the cargo 112 from the provider of transportation 13 (stage 19 and 21), in which case cargo data and/or data of emissions saved this way are registered in the server 10.

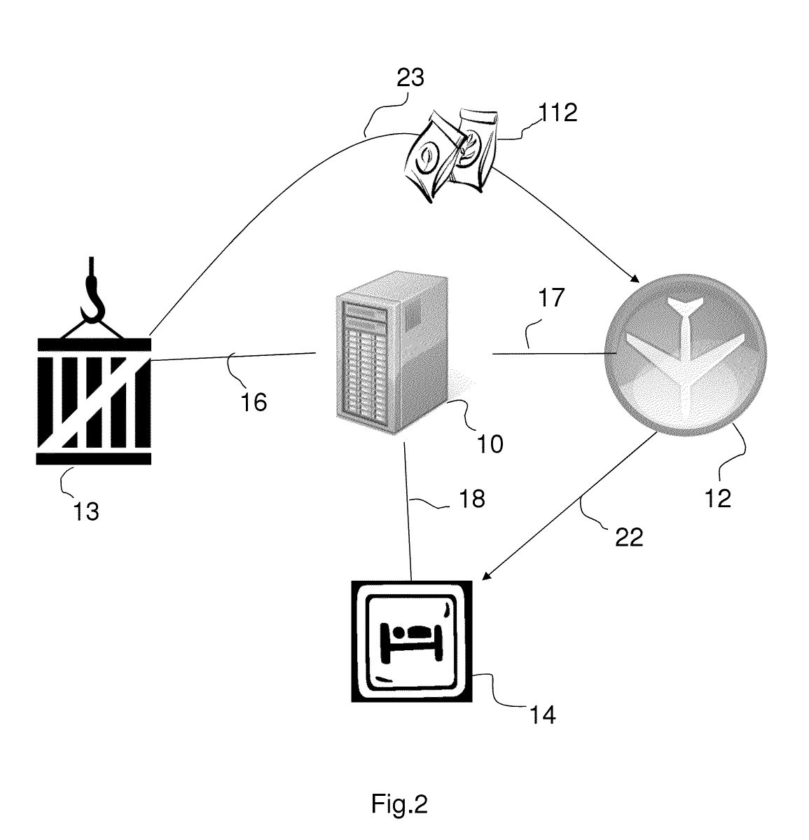

All cargo, for example, goods cargo 112 and passengers 111 can be registered and with the help of logistics, be arranged to constitute cargo compatible with the system 10, the emission data of its transportation being registered in the server 10. The cargo 112 can also be, for example, air cargo or other cargo that can be transported by air by the airline 12 (stage 20 and 22), but also by the provider of transportation 13 (by land or sea; stage 19 and 21), in which case the cargo is transported by other means than by air. Cargo can also be air cargo described in the afore-mentioned example of replacement cargo 112, as shown in FIG. 2.

For example, cargo 112 can be adjusted to the system at the initiative of either the passenger (alternatively the sender) 11 or the destination (alternatively the recipient) 14 or other party (e.g. provider of transportation service 13 or airline 12). In another example, cargo 112 is suitable for the system only if it is agreed to be suitable for the system already at the time of the order. In accordance with the system, cargo can, however, be agreed upon during or after the transportation. In an embodiment, cargo 12 covers air cargo, and in another embodiment, cargo 112 covers replacement cargo.

The system can contain an airline 12. The airline 12 has been connected 17 to the server 10. For example, the data of the passenger 111 and the baggage/replacement cargo 112 can been forwarded to the database 70. A two-way connection 17 has been arranged from the database 70 to the database of the airline 12 as well as the systems of its partners and client companies. The airline 12 flies 20 the passenger 111 as well as the cargo 112 to the destination 14 (stage 20 and 22).

The system can contain a provider of transportation service 13, for example, a transportation company or a forwarding company etc. The provider of transportation service 13 has been connected 16 to the server 10. For example, the data of the passenger 111 and the cargo 112 or the replacement cargo 112 can be managed in the database 70. There is a two-way connection 16 from the database 70 to the database of the provider of the transportation 13 as well as the systems of the airline 12 and the partners and client companies of the provider of the transportation.

The system can contain a target 14. Alternatively, the target 14 can be called endpoint, travel destination or recipient of the cargo. The target 14 can be a hotel, hotel chain, car rental, travel agency or other similar target point, such as the organizer of a conference etc., to which the cargo 112 and/or the passenger is supposed to go to or that otherwise is related to the cargo 112 or the passenger 11. The target 14 has been connected 18 with the server 10. For example, the target 14 and its database have been connected 18 to the database 70 and possibly to the systems of the transportations partners and client companies of the hotel chains/individual member hotels. Even different types of targets can be connected to each other in order to manage logistics at the target 14. There may, for example, be a connection to the database of the travel agency (chain), and the systems of airlines, hotels, car rentals and the partners and client companies of the afore-mentioned parties.

The system can contain more than one of each party, such as the airline 12, provider of transportation 13 and the target 14.

The server equipment 10 can be managed exclusively by the airline 12, the provider of transportation 13 or other party. For example, the airline 12 maintains the system in this respect. Similarly, a travel agency, for instance, can maintain the system or register data in the system.

Data saved in the server equipment 10 can be utilized also to the benefit of parties outside the system. For example, a hotel or a car rental can be provided with cargo and logistics data from the system for utilization. They can use the data, for example, in follow-up and reporting. Cargo, for example, can be delivered directly to a rental car or the hotel.

In an embodiment of FIG. 1, the passenger 111 is transported to the target 14 by the airline 20, 22. The cargo 112 of the passenger 11 is transported by the provider of transportation 13 to the target 19,21. Now, the cargo data and/or data regarding emissions saved of the cargo 112 are registered in the server 10.

In an embodiment of FIG. 2, the cargo 112 is transported to the target 14 by air 23,22. The sender of the cargo or the provider of transportation 13 delivers 23 the cargo to the airline 12. The airline flies 22 the cargo to the target 14. Now, it is possible that cargo data registered in the server 10, for example, data regarding emissions saved, are used in connection with this cargo. In this example, air cargo can therefore be transported with emissions generated by land cargo thanks to the combined emission application: air cargo is transported using air cargo capacity that has been liberated or will be liberated later or air cargo capacity for which the equivalent emission has been liberated or will be liberated later, when transporting cargo 112 by land instead of air.

### The Flight Process

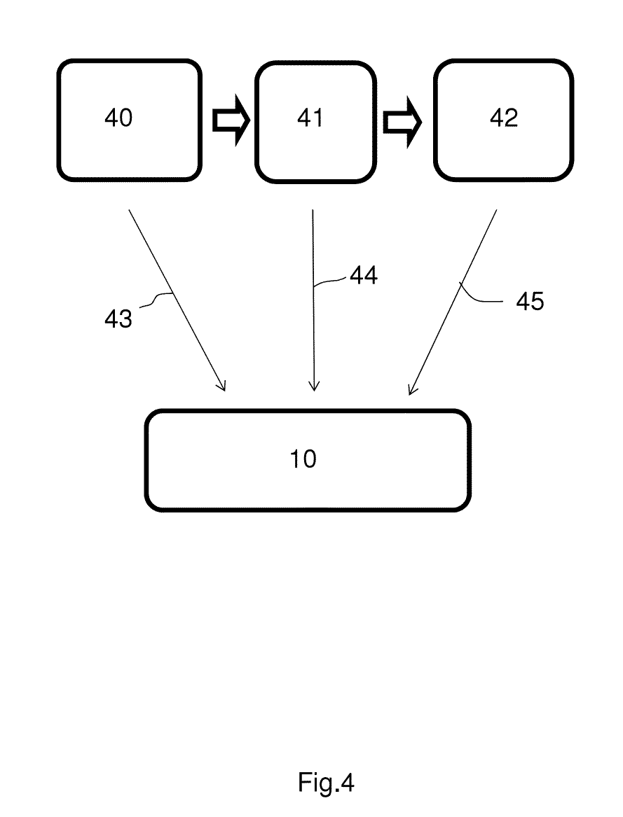

The embodiment in FIG. 4 presents a schematic figure of the flight process, where the flight is arranged in accordance with an embodiment of the present invention. In stage 40, the flight is defined as a flight compatible with the server 10. The flight and its data are suitable for the cargo and/or emission data to be registered and maintained on the server 10. The airline 12 communicates this to the server 10 (stage 43). The passenger 11 chooses a flight supporting the server 10 and the system (stage 41). The airline 12 (or the travel agency) informs the flight to the server (stage 44). At stage 42, the flight takes place, is delayed or cancelled, after which the airline 12 (or the travel agency) reports and informs to the server 10 the data pertaining to the flight; for example, if the compatible flight has taken place, been delayed or cancelled.

The server 10 makes the necessary entries into the database and the system. Also, the server 10 can update the account compatible with the service of both the airline 12 and the passenger 11 (e.g. the reservation and realization) and the data regarding the flight (e.g. the reservation) for another party, for instance, the travel agency or the passenger's employer (their server or similar).

### The Dispatch Process of Cargo

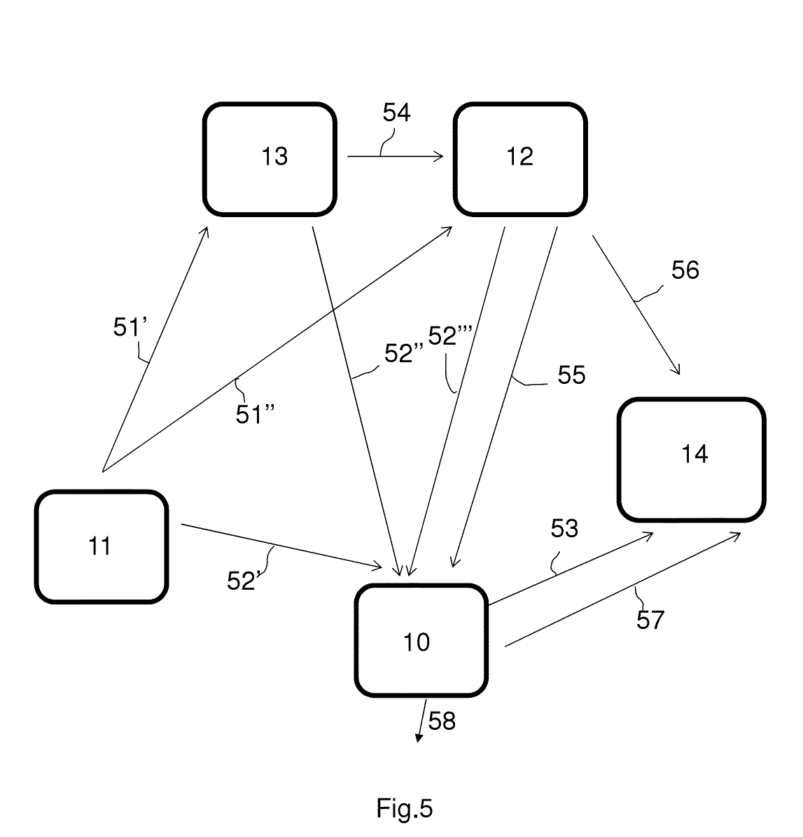

FIG. 5 shows schematically the dispatch process of the cargo 112, where the cargo 112 is arranged to be sent in accordance with an embodiment of the present invention. At stage 51, the company 11″ orders the transportation of the cargo 112 from the provider of the transportation service 13 (stage 51′) or directly from the airline 12 (51″). At stage 52 the sender of the cargo (52′), the provider of transportation 13 (52″) or the airline 12 (52′″) informs the server 10 of the ordering of the transportation of the cargo. The server 10 communicates the arriving cargo 112 to the target 14 of the cargo at stage 53. If the target 14 is not registered in the database, the server 10 can at the same time send information of the possibility to join the database registered on the server 10 and thereby have the cargo recorded on the server as compatible cargo. At stage 54, the provider of the transportation 13 hands the cargo 112 to the airline 12 for transportation. At stage 55, the airline 12 communicates the transportation of the cargo to the server 10. At stage 56, the pick-up or delivery to the target 14 of the cargo 112 is arranged either directly or with the help of additional distribution. At stage 57, the server 10 makes the entries of the cargo 112 to the system for the parties involved (in addition to entries regarding earlier stages). In the arrangement shown in FIG. 5, the cargo 112 can be transported so that the cargo is registered in the system for the registering of transportation of the cargo or emissions.

At stage 58, the server can communicate (one or more pieces of) data regarding the cargo or the flight to an external party (e.g. a travel agency or the passenger's employer).

### The Reception Process of Cargo

The following shows examples of situations where cargo compatible with the system is received:
1) Both the sender 11 and the target 14 as a recipient have been registered in the server 10, in which case it is possible to receive cargo that is compatible with the system irrespective of which of the parties (sender 11 or recipient 14) orders the transportation of the cargo.
2) The sender 11 of the cargo is registered in the server 10, but the recipient 14 is not. In that case, the recipient 14 can be asked whether he/she wishes to register and receive the cargo compatible with the system—for example, in accordance with the embodiment of FIG. 5.
3) The sender 11 has not been registered, but the recipient 14 is and wishes to receive the cargo as compatible with the system.
3.1) If the recipient 14 is not the orderer of the cargo, the recipient 14 can, for example, when purchasing the goods from the recipient inform the sender of the wish to receive the cargo as compatible with the system and possibly also communicate how the sender can register as a user of the system.

The sender 11 can register to the system in the server 10 and choose that the cargo is to be transported as cargo compatible with the system both in respect of the sender 11 and the recipient 14—for example, in accordance with the embodiment of FIG. 5.

Alternatively, if the sender 11 does not register (or at least does not choose a means of transportation compatible with the server 10), but the chosen transporter (airline 12 and/or provider of transportation 13) is, however, a transporter registered in the server 10, the cargo in question is compatible with the server 10 and can be eligible for emission reduction and be registered as cargo compatible with the system for the recipient 14 but not for the sender 11. If the transporter in question is not compatible, the cargo in question is not compatible, and no emission reduction can be granted, nor can the cargo be registered as compatible with the system for the recipient 14, either.

3.2) The recipient 14 is the orderer of the transportation, in which case, provided that the chosen transporter (airline 12 and/or provider of transportation service 13) is a transporter compatible with the server 10, the cargo in question is compatible with the system and can be eligible for emission reduction and be registered for the recipient 14, but not for the sender 11. If the transporter in question is not registered, the cargo is not compatible and no emission reduction can be granted nor the cargo be registered as cargo compatible with the system for the recipient 14.

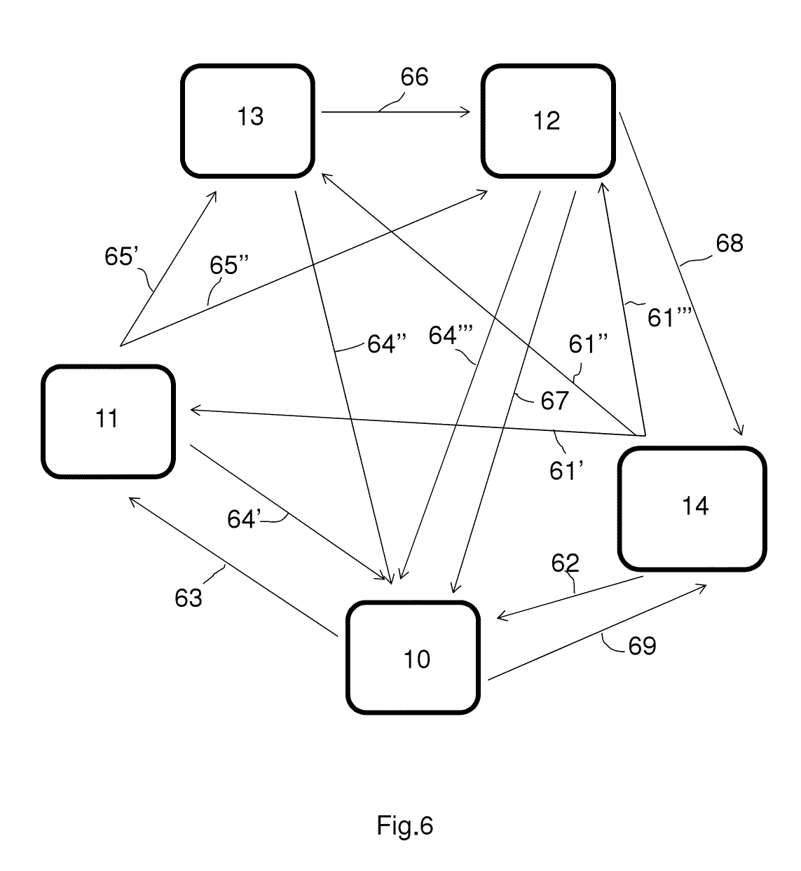

FIG. 6 is a schematic image of the reception process of cargo, where the cargo is arranged in accordance with an embodiment of the present invention. The example of FIG. 6 illustrates the reception of cargo in a case where the registered recipient 14 wishes to receive the cargo as cargo to be registered in the server 10 and the sender 11 has not been registered in the server 10 as, for example, in the situation 3.2) above. At stage 61 the recipient 14 orders the transportation from the airline 12 (stage 61′″), the provider of transportation 13 (stage 61″) or the sender of the goods 11 (stage 61′). As the recipient, the target 14 communicates the wish regarding the cargo to the server 10 at stage 62. The server 10 advises that the recipient 14 wishes the order as cargo compatible with the system and that the sender 11 can register with the system as well (stage 63). The sender 11 can register with the system and, if necessary, choose the appropriate parties from his/her transportation options.

64′, 64″ and 64′″: the party 11, 12, 13 having received a transportation order, advices of the transportation order, if they are registered in the system. Now the server 10 can register this data.

The sender 11 hands the ordered goods for transportation to the provider of transportation 13 (stage 65′) or directly to the airline (stage 65″). The provider of transportation 13 hands the cargo to be transported at stage 66. At stage 67, the airline 12 communicates the transportation of the cargo to the server 10. At stage 68, the cargo is picked up or delivered directly to the recipient 14, or alternatively, with additional help from the provider of transportation 13. Finally, the server 10 confirms to the recipient 14 the compatibility of the cargo for the sake of registration (stage 69) and enters the remarks of the cargo in question into its database 70 for the parties involved (in addition to remarks related to earlier stages) and may also inform external parties accordingly.

FIG. 7 shows the central server equipment 10 that can be configured in accordance with some embodiments of the present invention. The server 10 covers the database 70 and the processor unit 71. The afore-mentioned establish the data processing system on the server 10. The data processing system has been arranged to be in contact with the airline 12, the provider of transportation 13, the target 14 and, when necessary, the sender 11 or other party related to the passenger or the cargo, such as data processing systems. This makes the joining and using of the service possible to the parties. Alternatively, the server 10 can be decentralized (not shown in the figures) or in the form of a cloud service (not shown in the figures), in which case the server 10 covers the management and maintenance of data processing systems of all parties (point of origin/passenger 11, airline 12, provider of transportation 13 and target 14) for the applications of the invention. At this point, reference is also made to the embodiments presented in FIGS. 1, 2, 3, 4, 5 and 6.

The server 10 is arranged to maintain the information in the data processing system that the flight in question is compatible with the system and the cargo or passenger in question is compatible with the system. This data can be maintained in the database of the airline or other party involved, from which they are able to be transferred to the database of the server 10.

The system may contain additional options and alternatives, and the data can be arranged to be transferrable between parties of the system. The parties of the system are arranged for two-way data transfer.

For example, the system has been arranged to show that the flight in question is compatible with the service in the bibliographic data of the flight. Thereby, the passenger 11 sees the data in question and can take it into consideration when selecting a flight. It is also possible to search the system for compatible flights. A travel agency also has their own possibilities to highlight compatible flights.

The airline 12 decides by themselves which of their flights are arranged as compatible flights. The activity remains under control when compatible flights can be added gradually and the choices can be targeted in the most reasonable possible manner from the point of view of the airline 12. Under such circumstances, also the threshold to register will be lower.

The airline 12 can make good use of the data provided by the system. For example, in order to take the correct amount of replacement cargo and in order to assess the right amount of fuel for the airplane as well as in order to reserve the appropriate number of cabin crew for a given flight, it will be helpful to the airline 12 to be aware of the quantity of the cargo compatible/related to the system on the flight, for example passengers and cargo.

In an exemplary embodiment of the invention, the passenger 11 can check in part of his/her baggage 112 and have part transported using another means of transportation; for example, the suitcase may be checked in and the golf bag may be transported by other means. The passenger 111 can alternatively also have all of the baggage 112 transported using another means of transportation.

In an exemplary embodiment of the invention, the passenger 111 can declare that a delay of himself/herself and/or his/her baggage or a complete postponement of the flight is acceptable or tolerable. The passenger 111 declares when reserving the trip or later upon being asked to what extent a delay or postponement of the flight would be accepted. Also, the airline 12 may ask whether a delay or postponement differing from the earlier declaration of the passenger may be acceptable.

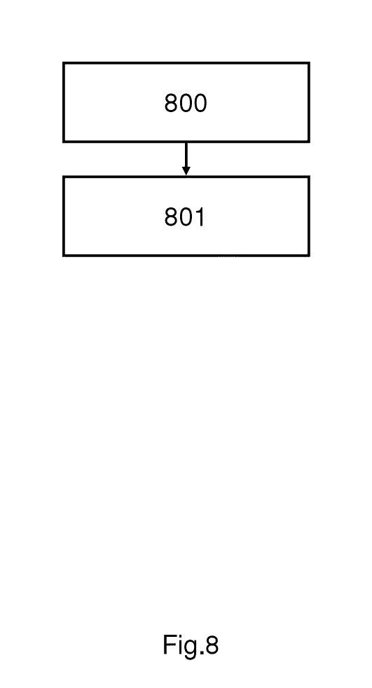

The FIG. 8 shows a schematic flowchart of the logistics process in accordance with an embodiment of the present invention. At stage 800 the cargo data is received. The cargo data pertain to the cargo to be transported by air and cargo to be transported by other means of transportation. The cargo data allows identifying cargo related to each other. In addition, in an embodiment the emission data regarding the transportation of the cargo is identified. At stage 801 the received cargo data are linked with each other. For example, the cargo data is registered for one or more parties of the cargo, so that the cargo data is available for the arranging of the transportation. Also the emission data is registered in the server 10. It is possible to be in contact to several providers of transportation 13 and airlines 12. The cargo data can be made available for several providers of transportation 13 and/or airlines 12 and if necessary, for other parties. They can be adjusted to organize the transportation of the cargo on this basis. The functionalities of the server 10 and the system presented afore can be carried out in methods in accordance with the invention.

The implementation of the invention does not require that the data pertaining to the passenger or other cargo is disclosed or registered in the order or to the extent presented in the exemplary alternatives, but the order and manner of disclosing or registering data can be different, and part of the data can also remain unregistered or undisclosed, provided that it does affect the implementation of the invention's idea to a relevant degree.

For a person skilled in the art, it is obvious that numerous modifications and variations can be made to the equipment and method. Other embodiments and exemplary implementations become evident to a person skilled in the art on the basis of the specification and practice related to the equipment and method described. The purpose is that the specification and the examples be regarded only as exemplary, so that the following patent claims and their equivalents show the actual scope of protection.

1. A server equipment that is configured to:
receive at least two pieces of cargo data, a part of which relates to a cargo to be transported by air and a part relates to a cargo to be transported by other means, wherein the at least two pieces of cargo data are associated to each other; and
link the received at least two pieces of cargo data to each other.

2. The server equipment of claim 1, wherein all or some of the cargo to be transported by other means is transported using essentially other means than the cargo to be transported by air.

3. The server equipment of claim 1, further configured to register the linking of the cargos in order to register emissions of the cargos.

4. The server equipment of claim 1, further configured to control the cargos to be joined at their destination.

5. The server equipment of claim 1, wherein the at least two pieces of cargo data are linked to each other so that the cargo to be transported by air has been arranged to be transported instead of land cargo, wherein the cargo corresponding to the air cargo has been arranged to be transported by land; or the cargos have been arranged to be joined at their destination.

6. Server equipment of claim 1, further configured to forward the at least one piece of cargo data to a provider of transportation, wherein the at least one piece of cargo data can be made available to the provider of transportation, and wherein the provider of transportation can be configured to organize the transportation of the cargo.

7. The server equipment of claim 1, further configured to forward the at least one piece of cargo data to an airline, wherein the at least one piece of cargo data can be made available to the airline, and wherein the airline can be configured to organize the transportation of the cargo.

8. The server equipment of claim 1 that has been configured to:
receive air cargo data pertaining to the cargo to be transported by air;
identify from the air cargo data emission data associated with the transportation of the air cargo;
register the emission data of the air cargo for one or more parties of the air cargo, wherein the emission data is registered in the server equipment,
forward the emission data to one or more providers of transportation, wherein the emission data can be made available to the one or more providers of transportation, and wherein the one or more providers of transportation can be configured to organize the transportation of the cargo.

9. The server equipment of claim 8, wherein the emission data comprises emission caused by energy needed for the transportation of the cargo from an origin to a destination.

10. The server equipment of claim 8, wherein the cargo comprises air cargo, land cargo or sea cargo depending on the means of transportation of the cargo, wherein the emission data is determined by the emission caused by the means of transportation.

11. The server equipment of claim 1, wherein the air cargo data comprises data regarding a passenger, baggage or other cargo transported by air or combined data of the above.

12. The server equipment of claim 8, wherein the emission data is determined by mass, transportation distance and the means of transportation of the cargo.

13. The server equipment of claim 8, wherein the emission data is associated with the passenger, airline, provider of transportation or a combination thereof, for whom the emission data is registered.

14. The server equipment of claim 1, wherein the provider of transportation of cargo has been configured to transport the cargo by land or by air.

15. The server equipment of claim 1, wherein the server is configured to be in contact with the passenger, the airline, the provider of transportation and the travel destination.

16. The server equipment of claim 1, wherein the server is configured to be in contact with the passenger, the airline, the provider of transportation and the travel destination or other party involved with the trip in order to control transportation logistics of the air cargo or cargo and to register the emission data.

17. The server equipment of claim 1, wherein the cargo data comprises information whether or not holder of the cargo allows a delay in the transportation, and the server is configured to receive this information and to forward it to the airline or the provider of transportation.

18. The server equipment of claim 17, wherein both pieces of cargo data comprise air cargo, wherein the cargo being transported by other means comprises air cargo that is delayed or changed to another flight.

19. The server equipment of claim 17, wherein the cargo has been provided with an entry regarding a delay or a change to another flight.

20. A method, comprising:
receiving at least two pieces of cargo data, a part of which pertains to a cargo to be transported by air and a part of which pertains to a cargo to be transported using other means, and wherein the at least two pieces of cargo data are associated with each other; and
linking the received at least two pieces of cargo data with each other.

21. An airline ticket that is configured to server equipment of claim 1 or to function in accordance with method of claim 20.

22. Air cargo that is configured to server equipment of claim 1 or to function in accordance with method of claim 20.

23. A provider of transportation that is configured to be in contact with the server equipment of the claim 1, wherein the at least one piece of cargo data can be made available to the provider of transportation, and wherein the provider of transportation can be configured to organize the transportation in accordance with the at least one piece of cargo data.

24. An airline that is configured to be in contact with the server equipment of the claim 1, wherein the at least one piece of cargo data can be made available to the airline, and wherein the airline can be configured to organize the transportation in accordance with the at least one piece of cargo data.

25. A computer program product, comprising software means that is configured to:
receive at least two pieces of cargo data, a part of which pertains to a cargo to be transported by air and a part of which pertains to a cargo to be transported using other means, and in which case the at least two pieces of cargo data are associated with each other; and
link the at least two pieces of cargo data with each other.

26. A system, comprising:
server equipment that is configured to:
receive at least two pieces of cargo data, a part of which pertains to a cargo to be transported by air and a part of which pertains to a cargo to be transported using other means, and in which case the at least two pieces of cargo data are associated with each other; and
link the at least two pieces of cargo data with each other;
forward the at least one piece of cargo data to one or more providers of transportation, wherein the one or more providers of transportation can be configured to organize the transportation of the cargo;
the provider of transportation that is configured to be in contact with the server equipment, and wherein the at least one piece of cargo data can be made available to the provider of transportation, and wherein the providers of transportation can be configured to organize the transportation of the cargo;
an airline that is configured to be in contact with the server equipment, wherein the at least one piece of cargo data can be made available to the airline, and wherein the airline can be configured to organize the transportation of the air cargo on the basis of the at least one piece of cargo data.
